(19) United States
(12) Patent Application Publication
(10) Pub. No.: US 2026/0169499 A1
(43) Pub. Date: Jun. 18, 2026

(54) A COMPUTER-IMPLEMENTED METHOD FOR CONTROLLING A VEHICLE SPEED OF AN AUTONOMOUS VEHICLE

(71) Applicant: Volvo Autonomous Solutions AB, Göteborg (SE)

(72) Inventors: Stefan BERGQUIST, Göteborg (SE); Linus HAGVALL, Göteborg (SE)

(73) Assignee: Volvo Autonomous Solutions AB, Göteborg (SE)

(21) Appl. No.: 19/125,945

(22) PCT Filed: Nov. 8, 2022
(86) PCT No.: PCT/EP2022/081170

§ 371 Date: Apr. 30, 2025

(51) Int. Cl. G05D 1/65; G05D 1/622; G05D 105/20; G05D 107/90; G05D 109/10; G05D 111/50

(52) U.S. Cl. CPC G05D 1/65; G05D 1/622; G05D 2105/20; G05D 2107/90; G05D 2109/10; G05D 2111/52

(57) ABSTRACT

A computer-implemented method controls a vehicle speed of an autonomous vehicle travelling within an area. The method includes detecting an inclination of a ground on which the vehicle is currently travelling, comparing the detected inclination to a first inclination interval indicative of a relatively level ground, determining if a predetermined condition is fulfilled, wherein the predetermined condition is considered fulfilled at least when the detected inclination is outside of the first inclination interval, when the predetermined condition is not fulfilled, controlling the vehicle speed to be below a first upper speed limit, when the predetermined condition is fulfilled, controlling the vehicle speed to be below a second upper speed limit, the second upper speed limit being higher than the first upper speed limit.

### TECHNICAL FIELD

The disclosure relates generally to the field of autonomous vehicle control. In particular aspects, the disclosure relates to a computer-implemented method for controlling a vehicle speed of an autonomous vehicle travelling within an area, such as a quarry or similar. The disclosure is not restricted to any particular vehicle but can for example be applied in vehicles within the fields of industrial construction machines or construction equipment, such as in haulers, wheel loaders, excavators, backhoe loaders, etc.

### BACKGROUND

On sites where autonomous vehicles are typically operated, such as in quarries or on construction sites, there are typically locations where the autonomous vehicles must share the space with manual vehicles and human operators, such as on loading and unloading locations. At such locations, it is crucial that the vehicle speed of the autonomous vehicle is sufficiently low not to compromise safety of vehicle operators and workers that may be present in the vicinity of the autonomous vehicle. Between the loading and unloading locations, however, there may be relatively long transport routes trafficked by autonomous vehicles only. Along such transport routes, the autonomous vehicles should preferably operate at a higher vehicle speed for productivity reasons.

To ensure safety in situations where the autonomous vehicle may encounter manual vehicles and humans, autonomous vehicles may rely on sensor-based collision avoidance systems in which sensors such as radars, cameras and/or lidars are used to detect objects and reduce vehicle speed in response thereto. However, varying environmental conditions make it difficult to guarantee safety of sensor-based collision avoidance systems. Furthermore, when possible to use such systems in view of safety requirements, the systems typically suffer from low performance and may therefore result in low vehicle speeds and false interventions, leading to low productivity.

Hence, it is desirable to find a way to on the one hand ensure safety on locations where humans and manual vehicles may be present, and on the other hand ensure that productivity is not lowered due to slow transportation of material within the sites.

### SUMMARY

According to a first aspect of the disclosure, a computer-implemented method for controlling a vehicle speed of an autonomous vehicle travelling within an area according to claim 1 is provided. The method comprises:
detecting an inclination of a ground on which the vehicle is currently travelling,
comparing the detected inclination to a first inclination interval indicative of a relatively level ground,
determining if a predetermined condition is fulfilled, wherein the predetermined condition is considered fulfilled at least when the detected inclination is outside of the first inclination interval,
when the predetermined condition is not fulfilled, controlling the vehicle speed to be below a first upper speed limit,
when the predetermined condition is fulfilled, controlling the vehicle speed to be below a second upper speed limit, the second upper speed limit being higher than the first upper speed limit.

The first aspect of the disclosure may seek to find an in at least some aspect improved method of controlling vehicle speed of autonomous vehicles. In particular, it may seek to ensure that vehicle speed is automatically lowered on locations where humans and manual vehicles may be present and increased when the vehicle travels between such locations. According to the disclosure, this is achieved by detecting the inclination of the ground on which the vehicle is travelling, such as a road inclination when the vehicle is travelling on a road. Hence, the method according to the disclosure is relevant for areas in which there is a difference in road inclination between locations in which manual users are expected and/or allowed to be present, and locations in which manual users are not expected and/or allowed. Such areas include sites in the form of an open pit, e.g., construction sites or quarries, in which manual users may be present at loading/unloading locations located on different levels within the pit. On the loading/unloading locations, the ground is relatively flat, i.e., the ground has a small absolute inclination. Transport roads between the loading/unloading locations, where no manual users are to be present, are relatively steep, i.e., have a larger absolute inclination. In this way, safety can be ensured at locations where manual users may be encountered without compromising overall productivity, since the vehicle is allowed to travel at an increased vehicle speed between those locations.

The method according to the disclosure further has an advantage over methods relying on geographic localization systems and geofencing to define high-risk and low-risk zones within a site, where the vehicle is allowed to travel at an increased vehicle speed in the low-risk zones. Since it is difficult to localize the vehicle with sufficiently large integrity to fulfill safety requirements, such methods require that the vehicle speed is limited over the entire site. In contrast, the method according to the disclosure allows the vehicle speed to be limited to relatively low speeds in areas where needed and increased elsewhere. Since the determination of inclination can be performed with high integrity using an inclination sensor or similar, the method is robust and reliable for areas such as quarries, in which there is a detectable difference in inclination between areas in which manual users are expected and other areas.

By the inclination is herein intended a longitudinal inclination, i.e., an inclination as seen in a longitudinal direction of travel of the vehicle. When the expression “absolute inclination” is used, it refers to an absolute value of the inclination. I.e., an absolute inclination below a threshold value includes both positive, i.e., upward inclinations below that threshold value, and negative, i.e., downward inclinations having an absolute value below the threshold value. The first inclination interval referred to herein may preferably include a zero angle of inclination and relatively small positive and/or negative inclination angles around zero. Such an inclination interval is indicative of a relatively level ground on which manual users may be allowed.

When the predetermined condition is fulfilled, such as when the vehicle is on a sloping ground, the vehicle speed is controlled to be below the second upper speed limit, and when the predetermined condition is not fulfilled, such as when the vehicle is on a level ground, the vehicle speed is controlled to be below the first upper speed limit. For example, the vehicle speed may be controlled to a first vehicle speed range when the predetermined condition is not fulfilled, and to a second vehicle speed range when the predetermined condition is fulfilled, wherein the second speed range is higher than the first speed range.

The area in which the autonomous vehicle is travelling may be a confined area, a defined area, or a delimited area. The area may preferably be an area in the form of an open pit, such as a quarry or a construction site. The area may include defined high safety zones in which manual users are allowed, where manual users are normally not allowed outside of those high safety zones. Limits of the first inclination interval may be set according to the topography of the area.

The computer-implemented method as disclosed herein may be performed in a processor device, such as in one or more electronic control units. The detection of the inclination may be performed by obtaining an inclination value in the processor device, or by, in the processor device, receiving data indicative of the inclination from, e.g., a sensor, and calculating the inclination from the received data.

Optionally, the predetermined condition is further considered fulfilled when the vehicle is within a predetermined range from a location at which the detected inclination was outside of the first inclination interval, such as from a location at which the detected inclination changed from being outside of the first inclination interval to being within the first inclination interval. This is beneficial when a loading/unloading location is not located immediately after a slope, since it allows the vehicle speed to be remain relatively high also when the vehicle has exited the slope. The predetermined range may be set in terms of distance or time, and it may be set according to a geography of the area. It may preferably be set such that it is smaller than a shortest distance between a slope and a location in which the inclination is within the first inclination interval in the area. In this way, it is ensured that the vehicle speed is reduced once it reaches a location in which manual users are allowed.

Optionally, the method further comprises controlling a steering angle of the vehicle and/or an operational mode of a collision mitigation system of the vehicle in dependence on whether the predetermined condition is fulfilled. This allows adaptation of the steering angle and the collision mitigation system in dependence on whether or not manual users are expected to be present around the autonomous vehicle. Hence, productivity can be prioritized when the vehicle is travelling between the high safety zones in which manual users are allowed, while as safety can be prioritized within the high safety zones.

Optionally, the method further comprises:
controlling the steering angle of the vehicle to be below a first steering angle threshold when the predetermined condition is not fulfilled, and
controlling the steering angle to be below a second steering angle threshold when the predetermined condition is fulfilled, the second steering angle threshold being higher than the first steering angle threshold.
   Hence, larger steering angles are allowed when the vehicle is on a sloping ground where no manual users are allowed, while as the steering angle is limited to smaller values once the vehicle enters a high safety zone.

Optionally, the method further comprises:
setting the operational mode of the collision mitigation system to a first mode when the predetermined condition is not fulfilled, and
setting the operational mode of the collision mitigation system to a second mode when the predetermined condition is fulfilled.
   The first mode of the collision mitigation system may typically be a mode which is more sensitive than the second mode, such that safety is always prioritized in the high safety zones. The sensitivity of a mode may be understood in terms of object size, detection distance, reflection strength, number of detections, etc. E.g., in a more sensitive mode, a weaker reflection, a smaller object, a fewer number of detections, etc., may trigger a collision mitigating action than in a less sensitive mode.

Optionally, the method further comprises:
controlling the collision mitigation system to be active, i.e., turned on, when the predetermined condition is not fulfilled, and
controlling the collision mitigation system to be inactive, i.e., turned off, when the predetermined condition is fulfilled.

Optionally, when the predetermined condition is fulfilled, the second upper speed limit is set to a first value when the detected inclination is indicative of a downhill travel direction, and to a second value when the detected inclination is indicative of an uphill travel direction. This allows the vehicle speed to be adjusted depending on whether the vehicle is travelling uphill or downhill.

Optionally, the method further comprises setting the first and second values of the second upper speed limit in dependence on the detected inclination. As an example, the first value of the second upper speed limit may be set to a smaller value at a steeper downhill inclination than at a smaller downhill inclination.

Optionally, the second value of the second upper speed limit is larger than the first value of the second upper speed limit. Hence, a lower vehicle speed is allowed for downhill travel of the vehicle than for uphill travel. Since a braking distance of the vehicle is larger for downhill travel, this ensures safe operation in high safety zones.

Optionally, detecting the inclination comprises measuring the inclination by using at least one inclination sensor of the vehicle. Additionally, or alternatively, detecting the inclination may comprise deriving the inclination from measurement data collected by at least one inertial measurement unit sensor of the vehicle. A sensor that allows determining the inclination, such as an inclination sensor or an inertial measurement unit (IMU) sensor, is normally present on autonomous vehicles for other purposes. An inclination sensor measures the angle with respect to a horizontal position of the vehicle. An imaginary line from the centre of the earth serves as a reference. An IMU sensor includes an accelerometer that measures acceleration in three directions.

Optionally, detecting the inclination comprises filtering of a measurement signal from the at least one inclination sensor and/or from the at least one inertial measurement unit sensor. Of course, filtering may be applied regardless of which sensor is used. The filtering allows instantaneous variations in inclination to be disregarded, such as variations arising due to the vehicle running over a small bump or debris. A more stable method may hence be achieved.

According to a second aspect of the disclosure, a computer system is provided. The computer system comprises a processor device configured to control a vehicle speed of an autonomous vehicle travelling within an area. The processor device is configured to:
detect an inclination of a ground on which the vehicle is currently travelling,
compare the detected inclination to a first inclination interval indicative of a relatively level ground,
determine if a predetermined condition is fulfilled, wherein the predetermined condition is considered fulfilled at least when the detected inclination is outside of the first inclination interval,
when the predetermined condition is not fulfilled, control the vehicle speed to be below a first upper speed limit,
when the predetermined condition is fulfilled, control the vehicle speed to be below a second upper speed limit, the second upper speed limit being higher than the first upper speed limit.

According to a third aspect of the invention, a computer program product comprising program code for performing the method according to the first aspect when said program is run on a processor device is provided.

According to a fourth aspect of the disclosure, a non-transitory computer-readable storage medium is provided. The non-transitory computer-readable storage medium comprises instructions, which when executed by a processor device, cause the processor device to perform the method according to the first aspect.

According to a fifth aspect of the disclosure, a control system for controlling a vehicle speed of an autonomous vehicle travelling within a defined area is provided. The control system comprises one or more electronic control units being configured to perform the method according to the first aspect.

Optionally, the control system further comprises at least one inclination sensor and/or at least one inertial measurement unit sensor communicatively connected to the at least one control unit.

According to a sixth aspect of the disclosure, a vehicle comprising the control system according to the fourth aspect is provided. The vehicle may be an autonomous vehicle, such as an autonomous working machine.

The above aspects, accompanying claims, and/or examples disclosed herein above and later below may be suitably combined with each other as would be apparent to anyone of ordinary skill in the art.

Additional features and advantages are disclosed in the following description, claims, and drawings, and in part will be readily apparent therefrom to those skilled in the art or recognized by practicing the disclosure as described herein.

### BRIEF DESCRIPTION OF THE DRAWINGS

With reference to the appended drawings, below follows a more detailed description of aspects of the disclosure cited as examples.

FIG. 1 is a schematic overview of an area in which an autonomous vehicle is operating.

FIG. 2 is a schematic view of an autonomous vehicle according to an example embodiment.

FIG. 3 is a flow chart illustrating an exemplary method according to the disclosure.

FIG. 4 is a schematic diagram of an exemplary computer system for implementing examples disclosed herein, according to one example.

The drawings are schematic and not drawn to scale.

### DETAILED DESCRIPTION

Aspects set forth below represent the necessary information to enable those skilled in the art to practice the disclosure.

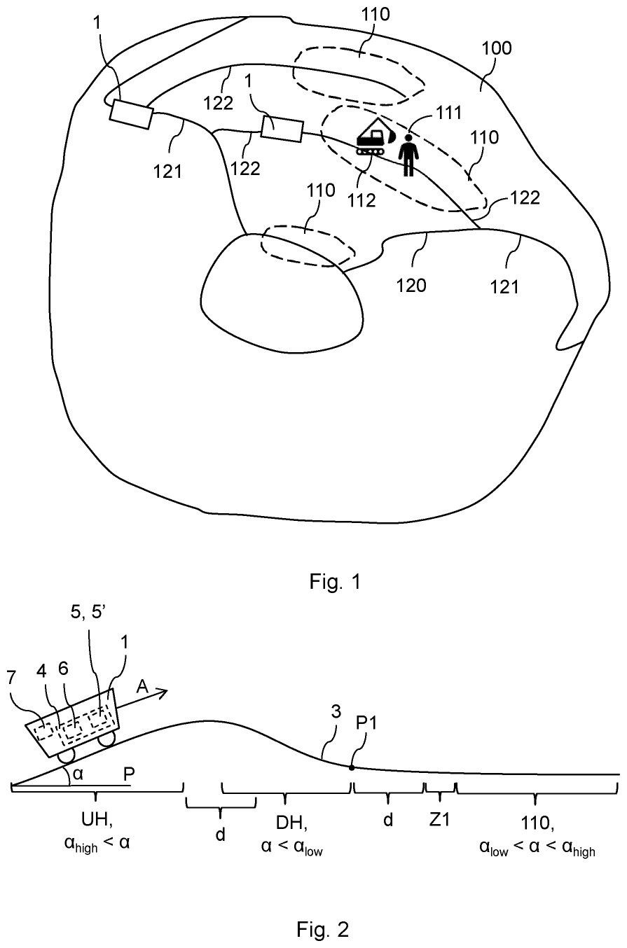

FIG. 1 shows an overview of an area 100 in the form of a quarry, in which an autonomous vehicle 1 is operated using a method according to an example embodiment of the present disclosure for controlling at least vehicle speed. The area 100 has the general shape of an open pit and comprises loading and unloading zones 110 located at several different levels within the area 100. In the loading and unloading zones 110, users 111, 112 in the form of humans 111 and manually operated vehicles 112 may be present. Hence, in those zones 110, the autonomous vehicles 1 are required to travel at a low speed for safety reasons. The autonomous vehicles 1 travel between the loading and unloading zones 110 via a network of roads 120. The roads 120 include relatively steep primary transport roads 121 as well as relatively level (flat) secondary transport roads 122, connecting the zones 110 to the primary transport roads 121. Along at least the primary transport roads 121, it is desirable that the autonomous vehicles 1 travel relatively fast in order to maintain a high productivity. Access to the area 100 may therefore be regulated so that humans 111 and manually operated vehicles 112 are only allowed to be present in the zones 110, and not outside of the zones 110, when autonomous vehicles 1 are operated within the area 100.

FIG. 2 illustrates an autonomous vehicle 1 travelling in a travelling direction A on a ground 3, such as within the area 100 illustrated in FIG. 1. The vehicle 1 is herein equipped at least one sensor 5, 5′ for detecting an inclination α of the ground 3, i.e., an angle of the ground 3 with respect to a horizontal plane P as seen in the travelling direction A. The sensor 5 may e.g., be an inclination sensor 5 configured to measure the inclination α, i.e., the angle with respect to a horizontal position of the vehicle, using an imaginary line from the centre of the earth as a reference. The inclination α is hence determined based on gravity. The inclination sensor 5 may also be referred to as an inclinometer or a tilt sensor. As a complement or an alternative, the sensor 5 may comprise other types of sensors configured to collect data from which the inclination α can be determined by a processor device of the sensor or by a processor device separate from the sensor, such as an inertial measurement unit (IMU) sensor 5′. Such an IMU sensor typically comprises at least a three-axis accelerometer for detecting linear acceleration and a three-axis gyroscope for detecting rotational rate. Several sensors 5, 5′ of the same type or of diverse types may be provided for determining the inclination α.

The vehicle 1 comprises a control system 4 for controlling the vehicle speed of the autonomous vehicle 1 when travelling within the area 100, such as in a quarry 100. The control system 4 is herein configured to control the vehicle speed to be below an upper speed limit set in dependence on the detected inclination, as will be described further below. The control system 4 comprises an electronic control unit 6, which may preferably be located onboard the vehicle 1 but which may also be remotely located and configured to communicate with an on-board unit via wireless communication. The sensor 5, 5′ may form part of the control system 4 as illustrated in FIG. 2, but it may also be separate from the control system 4 and configured to communicate with a unit thereof by wired or wireless communication.

The vehicle 1 may also comprise a collision mitigation system 7, such as a collision mitigation system comprising one or more sensors (not shown), e.g., camera(s), radar(s) and/or lidar(s). The collision mitigation system 7 may, e.g., be configured to automatically brake the vehicle 1 in response to detecting objects ahead of the vehicle 1 in the travelling direction. The collision mitigation system 7 may be settable to different modes of operation depending on various parameters, such as the location of the vehicle 1 and the vehicle speed. It may further be settable to different modes of operation depending on the inclination α as will be described further in the following.

The vehicle 1 further comprises a steering system (not shown) configured to steer the vehicle 1 by altering a steering angle. The control system 4 may be configured to control the steering angle of the vehicle 1 by setting upper limits for the steering angle depending on the detected inclination α. The control system 4 may thus be communicatively connected to the steering system.

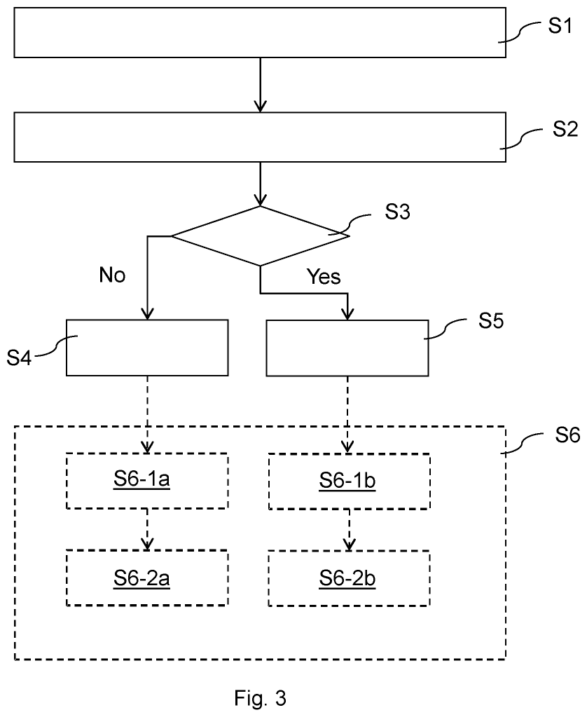

FIG. 3 illustrates a method for controlling the vehicle speed of the autonomous vehicle 1 travelling within the area 100 according to an example embodiment. The method comprises the actions listed in the following, which, unless otherwise indicated, may be taken in any suitable order. Unless otherwise indicated, the method may be performed by a processor device, such as by the electronic control unit 6.

Action S1: Detecting the inclination α of the ground 3 on which the vehicle 1 is currently travelling. This may comprise using the sensor 5 in the form of an inclination sensor for directly measuring the inclination α, or using another sensor as described above for collecting data that may be used for determining the inclination α. The inclination α may be determined in terms of an angle or in terms of a percentage value. The inclination α is further defined such that a negative value of the inclination α implies that the vehicle 1 is travelling downhill, and a positive value of the inclination α implies that the vehicle 1 is travelling uphill. Detecting the inclination α may comprise calculating the inclination α based on data communicated from the sensor 5, 5′, or obtaining the inclination α as determined by and communicated from the sensor 5, 5′.

The detection of the inclination α carried out in action S1 may comprise filtering of a measurement signal from the sensor 5 used to determine the inclination α. Purely by way of example, the filtering may be a low-pass filtering technique, such as moving average filtering. Such filtering is used to improve the robustness of the method and reduce the risk that temporary and/or erroneous deviations in the detected inclination α affect the velocity control of the vehicle 1.

Action S2: Comparing the detected inclination α to a first inclination interval α_{low}<α<α_{high} indicative of a relatively level ground. The first inclination interval α_{low}<α<α_{high} may be an interval centred on zero, or at least including a zero angle of inclination, i.e., a horizontal plane. The first inclination interval α_{low}<α<α_{high} may preferably include relatively small positive and/or negative inclination angles around zero, such as from a lower limit α_{low} being a negative value to an upper limit ahigh being a positive value. The absolute value |α_{high}| of the upper limit ahigh is not necessarily the same as the absolute value α_{low} of the lower limit α_{low}, although it may be the same. For example, the lower limit α_{low} may be between −5° and −1°, and the upper limit ahigh may be between +1° and +5°. For example, the first inclination interval may be set to −5°<α<5°, or −1°<α<1°. The first inclination interval α_{low}<α<α_{high} is set so that it includes the inclination of the ground 3 within the zones 110 and excludes the inclination of the ground 3 along the primary transport roads 121.

Action S3: Determining if a predetermined condition is fulfilled, wherein the predetermined condition is considered fulfilled at least when the detected inclination α, as detected in the action S2, is outside of the first inclination interval α_{low}<α<α_{high}. This indicates that the vehicle 1 is travelling on a relatively steep ground 3, such as on one of the primary transport roads 121, either uphill or downhill.

Action S4: The action S4 is carried out in response to that the predetermined condition was not found to be fulfilled in the action S3. This is the case when the vehicle 1 is located within one of the zones 110, where humans 111 and manually operated vehicles 112 may be present and where the ground 3 is relatively level, i.e., within the first inclination interval α_{low}<α<α_{high}. The action S4 comprises controlling the vehicle speed to be below a first upper speed limit. The first upper speed limit is set to a value which is considered safe around humans 111 and manual vehicles 112. The first upper speed limit may, e.g., be set to a value within the range of 5 -15 km/h.

Action S5: The action S5 is carried out in response to that the predetermined condition is fulfilled, i.e., that the vehicle is located on a sloping ground. The action S5 comprises controlling the vehicle speed to be below a second upper speed limit, the second upper speed limit being higher than the first upper speed limit. The second upper speed limit may, e.g., be set to a value within the range of 15-50 km/h. For example, the vehicle speed may be controlled to a first vehicle speed range when the predetermined condition is not fulfilled, and to a second vehicle speed range when the predetermined condition is fulfilled, the second vehicle speed range being larger than the first vehicle speed range.

Action S6: The method may optionally comprise the action S6 of controlling the steering angle of the vehicle 1, and/or of controlling the operational mode of the collision mitigation system 7 of the vehicle 1. The steering angle and/or the operational mode is/are herein controlled in dependence on whether the above defined predetermined condition is fulfilled. Hence, the action S6 may be carried out in parallel with the action S4 or S5.

The action S6 may, in an action S6-1a carried out when the predetermined condition is not fulfilled, such as when the vehicle 1 is within the zone 110, comprise controlling the steering angle to be below a first steering angle threshold. The action S6 may further, in an action S6-1b carried out when the predetermined condition is fulfilled, such as when the vehicle 1 travels along one of the primary transport roads 121 with a relatively large absolute inclination, comprise controlling the steering angle to be below a second steering angle threshold. In this case, the second steering angle threshold used on the relatively steep road sections where the predetermined condition is fulfilled may be higher than the first steering angle threshold used, e.g., in the zones 110.

When the predetermined condition is not fulfilled, the action S6 may further comprise an action S6-2a of setting the operational mode of the collision mitigation system 7 to a first mode. When the predetermined condition is fulfilled, the action S6 may instead comprise an action S6-2b of setting the operational mode of the collision mitigation system 7 to a second mode.

Reference is again made to FIG. 2 illustrating the autonomous vehicle 1 travelling on the ground 3. The predetermined condition used in action S3 may be set so that it is further considered fulfilled under some circumstances when the detected inclination α is within the first inclination interval α_{low}<α<α_{high}, i.e., on a relatively level ground. For example, the predetermined condition may be set so that it is considered fulfilled when the vehicle 1 is within a predetermined range d from a location P1 at which the detected inclination α was outside of the first inclination interval α_{low}<α<α_{high}. The range d may be set in terms of time or distance. Hence, when the vehicle 1 leaves a relatively steep road section, such as the primary transport road 121, and moves onto a less steep road section, such as onto the secondary transport road 122, it may still be allowed to travel at a vehicle speed above the first upper speed limit for some time or distance corresponding to the predetermined range d. In FIG. 2, the steeper road sections are illustrated by an uphill road section UH where the inclination α is larger than the upper limit α_{high} of the inclination interval α_{low}<α<α_{high} and a downhill road section DH where the inclination α is smaller than the lower limit α_{low}. The range d follows immediately on both of the uphill road section UH and the downhill road section DH. In the illustrated example, the range d following the uphill road section UH overlaps with a start of the downhill road section DH, while as the range d following the downhill road section DH does not overlap with any other road section at which the inclination α is outside of the first inclination interval α_{low}<α<α_{high}. Instead, the zone 110 is located ahead of the range d in the travel direction A. The loading and/or unloading zone 110 and the range r are defined such that a speed reduction zone Z1 separates the range r from the zone 110.

The predetermined range d may be set based on a geography/topography of the area 100 so that it is definitely shorter than the shortest distance between a steep section outside of the first inclination interval α_{low}<α<α_{high} and a zone 110 where humans 111 and manually operated vehicles 112 are entitled to be present. In this way, the vehicle 1 can efficiently transport material from the steep primary transport road 121 to the zone 110 without risking traveling at a too high speed when it enters the zone 110.

When the predetermined condition is fulfilled, such as when the inclination α is outside of the first inclination interval α_{low}<α<α_{high} or when the vehicle 1 is within the range d, the second upper speed limit may be set to a first value when the detected inclination α is indicative of a downhill travel direction, and to a second value when the detected inclination α is indicative of an uphill travel direction. Thus, it is not necessary to use the same upper speed limit for downhill and for uphill travel, although it is of course also possible to use a single second upper speed limit regardless of whether the inclination α is positive or negative. However, if different first and second values are set, it is preferable to set a larger second value than first value, such that the vehicle 1 may travel at a larger speed uphill than downhill. The reason for this is the larger braking distance during downhill travel. The first and second values of the second upper speed limit may further be set in dependence on the detected inclination. For example, a larger absolute inclination |α| may imply a lower second upper speed limit than a smaller absolute inclination |α|.

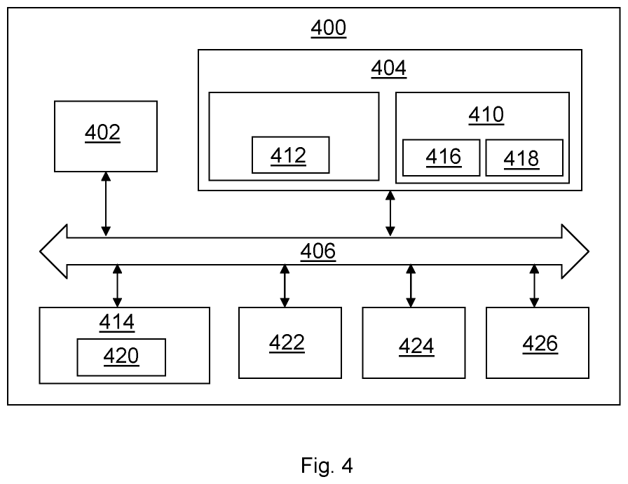

FIG. 4 is a schematic diagram of a computer system 400 for implementing examples disclosed herein. The computer system 400 is adapted to execute instructions from a computer-readable medium to perform these and/or any of the functions or processing described herein. The computer system 400 may be connected (e.g., networked) to other machines in a LAN, an intranet, an extranet, or the Internet. While only a single device is illustrated, the computer system 400 may include any collection of devices that individually or jointly execute a set (or multiple sets) of instructions to perform any one or more of the methodologies discussed herein. Accordingly, any reference in the disclosure and/or claims to a computer system, computing system, computer device, computing device, control system, control unit, electronic control unit (ECU), processor device, etc., includes reference to one or more such devices to individually or jointly execute a set (or multiple sets) of instructions to perform any one or more of the methodologies discussed herein. For example, control system may include a single control unit, or a plurality of control units connected or otherwise communicatively coupled to each other, such that any performed function may be distributed between the control units as desired. Further, such devices may communicate with each other or other devices by various system architectures, such as directly or via a Controller Area Network (CAN) bus, etc.

The computer system 400 may comprise at least one computing device or electronic device capable of including firmware, hardware, and/or executing software instructions to implement the functionality described herein. The computer system 400 may include one or more electronic control units 402, such as the control unit 6 illustrated in FIG. 2, which may also be referred to as a processor device, a memory 404, and a system bus 406. The computer system 400 may include at least one computing device having the control unit 402. The system bus 406 provides an interface for system components including, but not limited to, the memory 404 and the control unit 402. The control unit 402 may include any number of hardware components for conducting data or signal processing or for executing computer code stored in memory 404. The control unit 402 (e.g., processor device) may, for example, include a general-purpose processor, an application specific processor, a Digital Signal Processor (DSP), an Application Specific Integrated Circuit (ASIC), a Field Programmable Gate Array (FPGA), a circuit containing processing components, a group of distributed processing components, a group of distributed computers configured for processing, or other programmable logic device, discrete gate or transistor logic, discrete hardware components, or any combination thereof designed to perform the functions described herein. The control unit may further include computer executable code that controls operation of the programmable device.

The system bus 406 may be any of several types of bus structures that may further interconnect to a memory bus (with or without a memory controller), a peripheral bus, and/or a local bus using any of a variety of bus architectures. The memory 404 may be one or more devices for storing data and/or computer code for completing or facilitating methods described herein. The memory 404 may include database components, object code components, script components, or other types of information structure for supporting the various activities herein. Any distributed or local memory device may be utilized with the systems and methods of this description. The memory 404 may be communicably connected to the control unit 402 (e.g., via a circuit or any other wired, wireless, or network connection) and may include computer code for executing one or more processes described herein. The memory 404 may include non-volatile memory 408 (e.g., read-only memory (ROM), erasable programmable read-only memory (EPROM), electrically erasable programmable read-only memory (EEPROM), etc.), and volatile memory 410 (e.g., random-access memory (RAM)), or any other medium which can be used to carry or store desired program code in the form of machine-executable instructions or data structures and which can be accessed by a computer or other machine with a control unit 402. A basic input/output system (BIOS) 412 may be stored in the non-volatile memory 408 and can include the basic routines that help to transfer information between elements within the computer system 400.

The computer system 400 may further include or be coupled to a non-transitory computer-readable storage medium such as the storage device 414, which may comprise, for example, an internal or external hard disk drive (HDD) (e.g., enhanced integrated drive electronics (EIDE) or serial advanced technology attachment (SATA)), HDD (e.g., EIDE or SATA) for storage, flash memory, or the like. The storage device 414 and other drives associated with computer-readable media and computer-usable media may provide non-volatile storage of data, data structures, computer-executable instructions, and the like.

A number of modules can be implemented as software and/or hard-coded in circuitry to implement the functionality described herein in whole or in part. The modules may be stored in the storage device 414 and/or in the volatile memory 410, which may include an operating system 416 and/or one or more program modules 418. All or a portion of the examples disclosed herein may be implemented as a computer program product 420 stored on a transitory or non-transitory computer-usable or computer-readable storage medium (e.g., single medium or multiple media), such as the storage device 414, which includes complex programming instructions (e.g., complex computer-readable program code) to cause the control unit 402 to carry out the steps described herein. Thus, the computer-readable program code can comprise software instructions for implementing the functionality of the examples described herein when executed by the control unit 402. The control unit 402 may serve as a controller or control system for the computer system 400 that is to implement the functionality described herein, such as for the control system 4 illustrated in FIG. 2.

The computer system 400 also may include an input device interface 422 (e.g., input device interface and/or output device interface). The input device interface 422 may be configured to receive input and selections to be communicated to the computer system 400 when executing instructions, such as from a keyboard, mouse, touch-sensitive surface, etc. Such input devices may be connected to the processor device 402 through the input device interface 422 coupled to the system bus 406 but can be connected through other interfaces such as a parallel port, an Institute of Electrical and Electronic Engineers (IEEE) 1394 serial port, a Universal Serial Bus (USB) port, an IR interface, and the like. The computer system 400 may include an output device interface 424 configured to forward output, such as to a display, a video display unit (e.g., a liquid crystal display (LCD) or a cathode ray tube (CRT)). The computer system 400 may also include a communications interface 426 suitable for communicating with a network as appropriate or desired.

The operational steps described in any of the exemplary aspects herein are described to provide examples and discussion. The steps may be performed by hardware components, may be embodied in machine-executable instructions to cause a processor to perform the steps, or may be performed by a combination of hardware and software. Although a specific order of method steps may be shown or described, the order of the steps may differ. In addition, two or more steps may be performed concurrently or with partial concurrence.

The terminology used herein is for the purpose of describing particular aspects only and is not intended to be limiting of the disclosure. As used herein, the singular forms “a,” “an,” and “the” are intended to include the plural forms as well, unless the context clearly indicates otherwise. As used herein, the term “and/or” includes any and all combinations of one or more of the associated listed items. It will be further understood that the terms “comprises,” “comprising,” “includes,” and/or “including” when used herein specify the presence of stated features, integers, steps, operations, elements, and/or components, but do not preclude the presence or addition of one or more other features, integers, steps, operations, elements, components, and/or groups thereof.

It will be understood that, although the terms first, second, etc., may be used herein to describe various elements, these elements should not be limited by these terms.

These terms are only used to distinguish one element from another. For example, a first element could be termed a second element, and, similarly, a second element could be termed a first element without departing from the scope of the present disclosure.

Relative terms such as “below” or “above” or “upper” or “lower” or “horizontal” or “vertical” may be used herein to describe a relationship of one element to another element as illustrated in the Figures. It will be understood that these terms and those discussed above are intended to encompass different orientations of the device in addition to the orientation depicted in the Figures. It will be understood that when an element is referred to as being “connected” or “coupled” to another element, it can be directly connected or coupled to the other element, or intervening elements may be present. In contrast, when an element is referred to as being “directly connected” or “directly coupled” to another element, there are no intervening elements present.

Unless otherwise defined, all terms (including technical and scientific terms) used herein have the same meaning as commonly understood by one of ordinary skill in the art to which this disclosure belongs. It will be further understood that terms used herein should be interpreted as having a meaning consistent with their meaning in the context of this specification and the relevant art and will not be interpreted in an idealized or overly formal sense unless expressly so defined herein.

It is to be understood that the present disclosure is not limited to the aspects described above and illustrated in the drawings; rather, the skilled person will recognize that many changes and modifications may be made within the scope of the present disclosure and appended claims. In the drawings and specification, there have been disclosed aspects for purposes of illustration only and not for purposes of limitation, the scope of the inventive concepts being set forth in the following claims.

1. A computer-implemented method for controlling a vehicle speed of an autonomous vehicle travelling within an area, the method comprising:
detecting an inclination of a ground on which the vehicle is currently travelling,
comparing the detected inclination to a first inclination interval indicative of a relatively level ground,
determining if a predetermined condition is fulfilled, wherein the predetermined condition is considered fulfilled at least when the detected inclination is outside of the first inclination interval, when the predetermined condition is not fulfilled, controlling the vehicle speed to be below a first upper speed limit,
when the predetermined condition is fulfilled, controlling the vehicle speed to be below a second upper speed limit, the second upper speed limit being higher than the first upper speed limit.

2. The method according to claim 1, wherein the predetermined condition is further considered fulfilled when the vehicle is within a predetermined range from a location at which the detected inclination was outside of the first inclination interval.

3. The method according to claim 1, further comprising:
controlling a steering angle of the vehicle and/or an operational mode of a collision mitigation system of the vehicle in dependence on whether the predetermined condition is fulfilled.

4. The method according to claim 3, further comprising:
controlling the steering angle of the vehicle to be below a first steering angle threshold when the predetermined condition is not fulfilled, and
controlling the steering angle to be below a second steering angle threshold when the predetermined condition is fulfilled, the second steering angle threshold being higher than the first steering angle threshold.

5. The method according to claim 3, further comprising:
setting the operational mode of the collision mitigation system to a first mode when the predetermined condition is not fulfilled, and
setting the operational mode of the collision mitigation system to a second mode when the predetermined condition is fulfilled.

6. The method according to claim 1, wherein, when the predetermined condition is fulfilled, the second upper speed limit is set to a first value when the detected inclination is indicative of a downhill travel direction, and to a second value when the detected inclination is indicative of an uphill travel direction.

7. The method according to claim 6, further comprising:
setting the first and second values of the second upper speed limit in dependence on the detected inclination.

8. The method according to claim 6, wherein the second value of the second upper speed limit is larger than the first value.

9. The method according to claim 1, wherein detecting the inclination comprises measuring the inclination by using at least one inclination sensor of the vehicle, and/or wherein detecting the inclination comprises deriving the inclination from measurement data collected by at least one inertial measurement unit sensor of the vehicle.

10. The method according to claim 9, wherein detecting the inclination comprises filtering of a measurement signal from the at least one inclination sensor and/or from the at least one inertial measurement unit sensor.

11. A computer system comprising a processor device configured to control a vehicle speed of an autonomous vehicle travelling within an area, the processor device being configured to:
detect an inclination of a ground on which the vehicle is currently travelling,
compare the detected inclination to a first inclination interval indicative of a relatively level ground,
determine if a predetermined condition is fulfilled, wherein the predetermined condition is considered fulfilled at least when the detected inclination is outside of the first inclination interval,
when the predetermined condition is not fulfilled, control the vehicle speed to be below a first upper speed limit,
when the predetermined condition is fulfilled, control the vehicle speed to be below a second upper speed limit, the second upper speed limit being higher than the first upper speed limit.

12. A computer program product comprising program code for performing the method of claim 1 when said program is run on a processor device.

13. A non-transitory computer-readable storage medium comprising instructions, which when executed by a processor device, cause the processor device to perform the method of claim 1.

14. A control system for controlling a vehicle speed of an autonomous vehicle travelling within an area, the control system comprising one or more electronic control units being configured to perform the method according to claim 1.

15. The control system according to claim 14, further comprising at least one inclination sensor and/or at least one inertial measurement unit sensor communicatively connected to the at least one control unit.

16. A vehicle comprising the control system of claim 14.
